(19) United States
(12) Patent Application Publication
(10) Pub. No.: US 2025/0383724 A1
(43) Pub. Date: Dec. 18, 2025

(54) STYLUS AND ELECTRONIC DEVICE

(71) Applicant: WUHAN CHINA STAR OPTOELECTRONICS SEMICONDUCTOR DISPLAY TECHNOLOGY CO., LTD., Wuhan, Hubei (CN)

(72) Inventor: Qi JIANG, Wuhan, Hubei (CN)

(21) Appl. No.: 17/758,106

(22) PCT Filed: Jun. 10, 2022
(86) PCT No.: PCT/CN2022/098127

§ 371 Date: Jan. 29, 2025

(30) Foreign Application Priority Data
May 26, 2022 (CN) 202210588734.0

(51) Int. Cl. G06F 3/0354

(52) U.S. Cl. CPC G06F 3/03545

(57) ABSTRACT

A stylus and an electronic device are disclosed. The stylus includes a nib, and the nib includes a main body and a surface modification layer. The surface modification layer covers the main body, and a hardness of the surface modification layer is less than a hardness of the main body, which can prevent scratches and damages to a touch display panel, thereby effectively extending a service life of the touch display panel.

### FIELD OF INVENTION

The present disclosure relates to the field of display technologies, and more particularly, to a stylus and an electronic device.

### BACKGROUND OF INVENTION

With acceleration of people's life rhythm and development of scientific and technological networks, a demand for large-screen terminals continues to increase. In order to make the large-screen terminals more portable, foldable mobile phones and other terminals have emerged. On this basis, a demand for writing pens that match the large-screen terminals is also increasing. Due to their basic bending requirements, coverplates of foldable screens cannot use glass used for non-bending screens. Materials such as colorless polyimide (CPI) and polyethylene terephthalate (PET) are usually used for the coverplates, and surface thereof will be coated with a hard coating layer having a thickness of 3 to 15 microns. The surface hardness and abrasion resistance of such organic materials are much lower than those of glass. Therefore, the design of styluses for foldable screens is very important.

Due to the limitation of the material of the coverplates and use of each adhesive layer in modules, a surface hardness of the foldable screens or terminals is generally not high. Therefore, the styluses are easy to cause wear and damages to the foldable screens.

### SUMMARY OF INVENTION

### Technical Problem

An embodiment of the present disclosure provides a stylus and an electronic device, which can solve a technical problem of styluses being prone to cause wear and damages to the foldable screens.

### Solution to Issue

### Technical Solution

An embodiment of the present disclosure provides a stylus, which includes a nib, wherein the nib includes:

a main body; and

a surface modification layer covering the main body, wherein, a hardness of the surface modification layer is less than a hardness of the main body.

Optionally, in some embodiments of the present disclosure, a material of the surface modification layer is a polymer fiber, and the polymer fiber is wound around the main body.

Optionally, in some embodiments of the present disclosure, a diameter of the polymer fiber ranges from 50 nm to 2000 nm.

Optionally, in some embodiments of the present disclosure, a material of the surface modification layer includes one or more of polyoxymethylene, polyamide, or polycarbonate.

Optionally, in some embodiments of the present disclosure, the surface modification layer has a pencil hardness less than or equal to 2B.

Optionally, in some embodiments of the present disclosure, a height of the surface modification layer along an axial direction of the stylus ranges from 3 mm to 10 mm.

Optionally, in some embodiments of the present disclosure, a thickness of the surface modification layer is less than or equal to 1 mm.

Optionally, in some embodiments of the present disclosure, the stylus further includes a pen body, wherein, a first end of the main body is connected to the pen body, the surface modification layer covers at least a second end of the main body, the main body is a solid of revolution, and an outside diameter of the second end of the main body is less than or equal to 1 mm.

Optionally, in some embodiments of the present disclosure, a contour line of a longitudinal section of an end surface of the second end of the main body satisfies a following formula:

y=nx²;

wherein, n is a non-zero real number, and a y-axis of the contour line is parallel to an axial direction of the stylus.

Optionally, in some embodiments of the present disclosure, an end surface of the second end of the main body is a sphere, and a diameter of the sphere is less than or equal to 1 mm.

An embodiment of the present disclosure further provides an electronic device, which includes:

a touch display panel; and

the stylus mentioned above.

Optionally, in some embodiments of the present disclosure, a material of the surface modification layer is a polymer fiber, and the polymer fiber is wound around the main body.

Optionally, in some embodiments of the present disclosure, a diameter of the polymer fiber ranges from 50 nm to 2000 nm.

Optionally, in some embodiments of the present disclosure, a material of the surface modification layer includes one or more of polyoxymethylene, polyamide, or polycarbonate.

Optionally, in some embodiments of the present disclosure, the surface modification layer has a pencil hardness less than or equal to 2B.

Optionally, in some embodiments of the present disclosure, a height of the surface modification layer along an axial direction of the stylus ranges from 3 mm to 10 mm.

Optionally, in some embodiments of the present disclosure, a thickness of the surface modification layer is less than or equal to 1 mm.

Optionally, in some embodiments of the present disclosure, the stylus further includes a pen body, wherein, a first end of the main body is connected to the pen body, the surface modification layer covers at least a second end of the main body, the main body is a solid of revolution, and an outside diameter of the second end of the main body is less than or equal to 1 mm.

Optionally, in some embodiments of the present disclosure, a contour line of a longitudinal section of an end surface of the second end of the main body satisfies a following formula:

y=nx²;

wherein, n is a non-zero real number, and a y-axis of the contour line is parallel to an axial direction of the stylus.

Optionally, in some embodiments of the present disclosure, an end surface of the second end of the main body is a sphere, and a diameter of the sphere is less than or equal to 1 mm.

### Beneficial Effect of Invention

### Beneficial Effect

The embodiments of the present disclosure use the stylus and the electronic device. By covering the surface modification layer on the main body of the nib and setting the hardness of the surface modification layer to be less than the hardness of the main body, scratches and damages to a touch display panel can be prevented, thereby effectively extending a service life of the touch display panel.

### BRIEF DESCRIPTION OF DRAWINGS

### Description of Drawings

The accompanying figures to be used in the description of embodiments of the present disclosure will be described in brief to more clearly illustrate the technical solutions of the embodiments. The accompanying figures described below are only part of the embodiments of the present disclosure, from which those skilled in the art can derive further figures without making any inventive efforts.

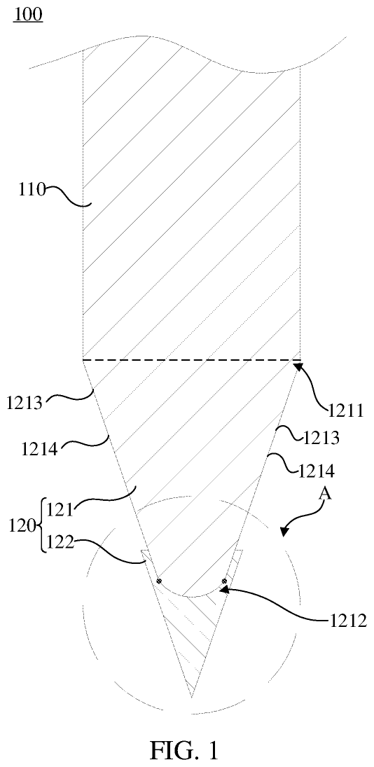

FIG. 1 is a first schematic structure diagram of a stylus according to an embodiment of the present disclosure.

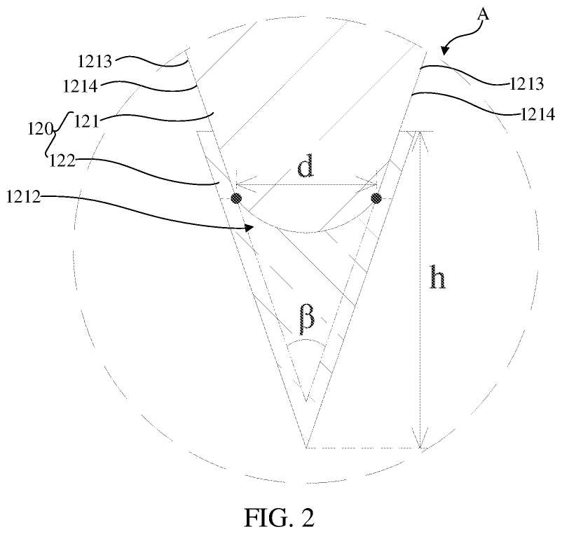

FIG. 2 is an enlarged schematic structural diagram of an area A in FIG. 1 according to an embodiment of the present disclosure.

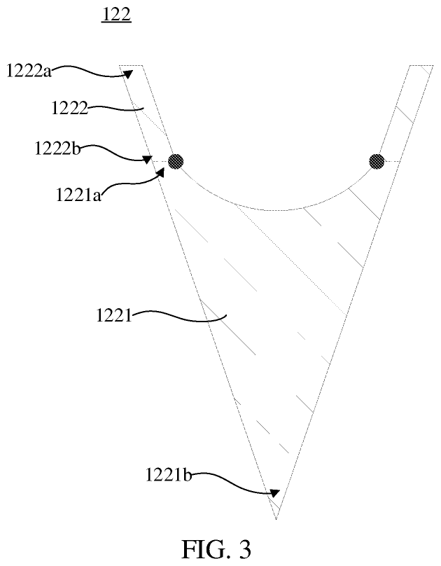

FIG. 3 is a first schematic structural diagram of a surface modification layer according to an embodiment of the present disclosure.

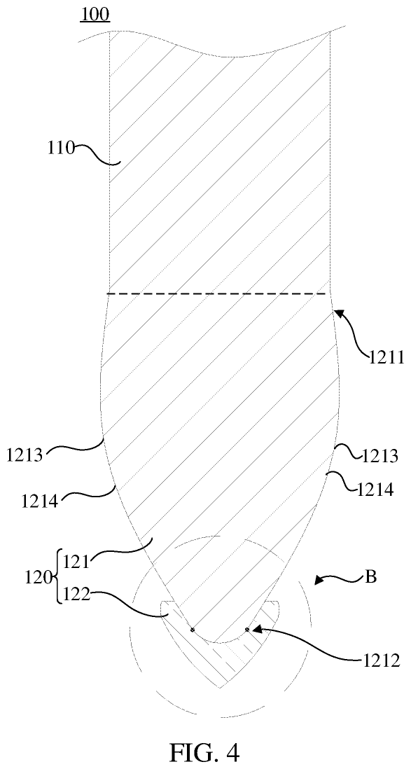

FIG. 4 is a second schematic structure diagram of the stylus according to an embodiment of the present disclosure.

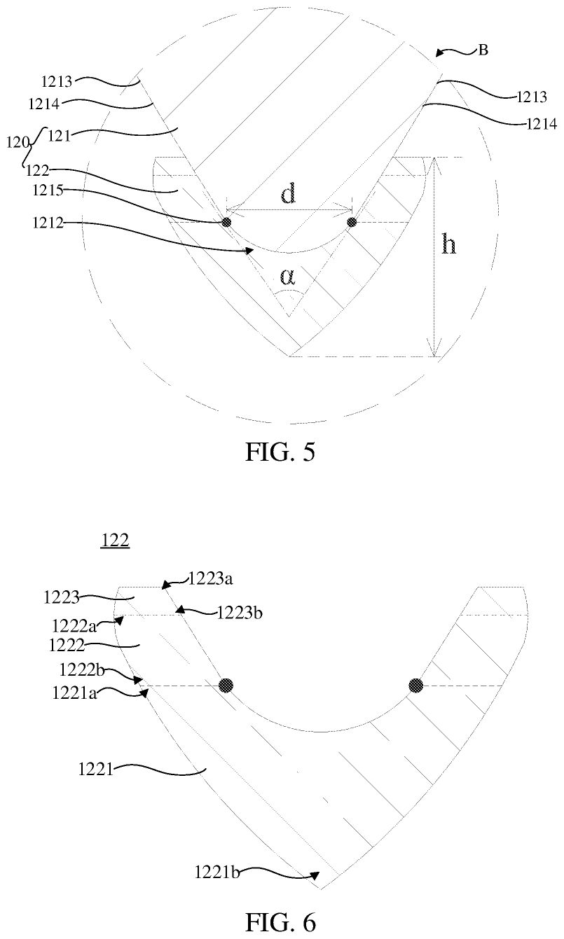

FIG. 5 is an enlarged schematic structural diagram of an area B in FIG. 4 according to an embodiment of the present disclosure.

FIG. 6 is a second schematic structural diagram of the surface modification layer according to an embodiment of the present disclosure.

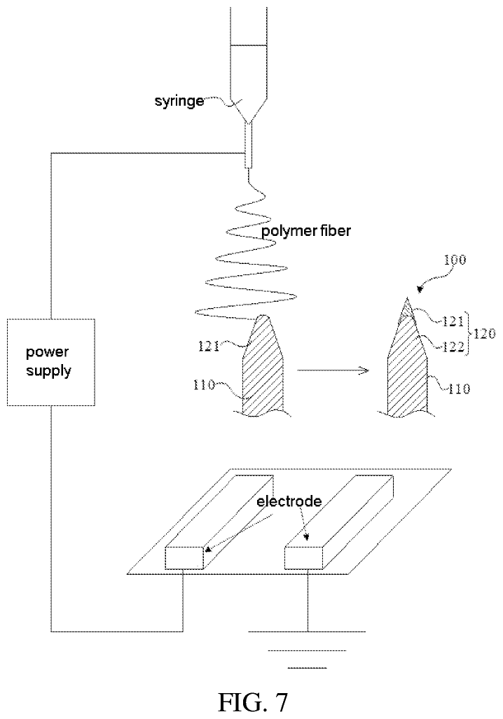

FIG. 7 is a schematic diagram of fabrication of the stylus according to an embodiment of the present disclosure.

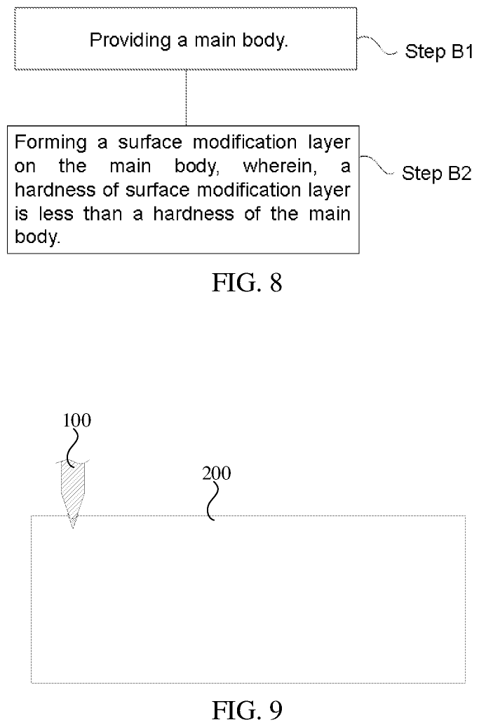

FIG. 8 is a flowchart of a manufacturing method of the stylus according to an embodiment of the present disclosure.

FIG. 9 is a schematic structural diagram of an electronic device according to an embodiment of the present disclosure.

### EMBODIMENTS OF INVENTION

### Description of Embodiments of Invention

The technical solutions in the embodiments of the present disclosure will be clearly and completely described below with reference to the drawings in the embodiments of the present disclosure. Obviously, the described embodiments are only a part of the embodiments of the present disclosure, but not all the embodiments. Based on the embodiments in the present disclosure, all other embodiments obtained by those skilled in the art without creative efforts are within the scope of the present disclosure. In addition, it should be understood that the specific embodiments described herein are only used to illustrate and explain the disclosure, and are not used to limit the disclosure. In the present disclosure, in the case of no explanation to the contrary, the orientation words used such as “on” and “under” usually refer to upper and lower directions of the device in actual use or working state, and specifically the directions in the drawings; and “inside” and “outside” refers to the outline of the device.

The embodiments of the present disclosure provide a stylus and an electronic device. They will be described in detail in the following. It should be noted that an order of description in the following embodiments is not meant to limit a preferred order of the embodiments.

Referring to FIGS. 1 and 2, an embodiment of the present disclosure provides a stylus 100, which includes a nib 120, and the nib 120 includes a main body 121 and a surface modification layer 122. Wherein, the surface modification layer 122 covers a surface of the main body 121, and a hardness of the surface modification layer 122 is less than a hardness of the main body 121.

In the stylus 100 of this embodiment, by covering the surface modification layer 122 on the main body 121 of the nib 120 and setting the hardness of the surface modification layer 122 to be less than the hardness of the main body 121, scratches and damages to screens can be prevented, thereby effectively extending a service life of the screens.

Specifically, a coverplate of the screens usually has a pencil hardness of 6B. In order to further prevent the screens from being scratched and damaged, the surface modification layer 122 has a pencil hardness less than or equal to 2B, thereby preventing the stylus 100 from scratching and damaging the screens.

Specifically, when the stylus 100 is used, only a pen point portion of the nib 120 will be in contact with the screens. If the surface modification layer 122 is set at a place other than the pen point portion of the nib 120, it will lead to waste and higher cost. If the surface modification layer 122 cannot fully cover the pen point portion of the nib 120, there is still a possibility of scratching or damaging the screens. In order to prevent the above problems, as shown in FIG. 2, a height h of the surface modification layer 122 along an axial direction of the stylus 100 may be set to range from 3 mm to 10 mm. By the above settings, production cost can be controlled, and a scratch-resistant effect of the stylus 100 can be ensured.

In the stylus 100 of the embodiment of the present disclosure, the height h of the surface modification layer 122 along the axial direction of the stylus 100 may be 3 mm, 4 mm, 5 mm, 6 mm, 7 mm, 8 mm, 9 mm, or 10 mm. Of course, the height h of the surface modification layer 122 along the axial direction of the stylus 100 may be appropriately adjusted according to selections of actual situations and settings of specific requirements, which is not limited here.

Specifically, if a thickness of the surface modification layer 122 is too large, on one hand, it will increase the cost of the stylus 100, and on another hand, it will increase a weight and a manufacturing difficulty of the stylus 100, and the user experience will be low. If the thickness of surface modification layer 122 is too small, it will not be able to play a good anti-scratch effect. In order to prevent the above problems, the thickness of the surface modification layer 122 may be set to be less than or equal to 1 mm. By the above settings, the manufacturing difficulty can be reduced, the production cost can be effectively controlled, and the weight of the stylus 100 can be reduced at the same time, thereby greatly improving the user experience.

In the stylus 100 of the embodiment of the present disclosure, the thickness of the surface modification layer 122 may be 0.1 mm, 0.2 mm, 0.3 mm, 0.4 mm, 0.5 mm, 0.6 mm, 0.7 mm, 0.8 mm, 0.9 mm, or 1 mm. Of course, the thickness of the surface modification layer 122 may be appropriately adjusted according to selections of actual situations and settings of specific requirements, which is not limited here.

In current technology, a shape of the pen point is usually conical, which increases the probability of scratching and damaging the screens. In order to prevent the above problems, the shape of the pen point is usually set to be a column shape. Although this design can effectively reduce scratching of screen surfaces by the pen point, a wide pen point greatly sacrifices the experiences of using the stylus 100. Specifically, in order to reduce wear of the screens by the stylus 100 while ensuring the user experience, as shown in FIGS. 1 and 2, the stylus 100 further includes a pen body 110. Wherein, a first end 1211 of the main body 121 is connected to the pen body 110, the surface modification layer 122 covers at least a second end 1212 of the main body 121, the main body 121 is a solid of revolution, and an outside diameter d of the second end 1212 of the main body 121 is less than or equal to 1 mm. By the above settings, a part of the surface modification layer 122 corresponding to the second end 1212 of the main body 121 can be ensured to have a thin pen point, thereby satisfying the needs of users for more realistic writing. In addition, since the hardness of the surface modification layer 122 is less, the scratches on the screen surfaces can also be reduced.

In the stylus 100 of the embodiment of the present disclosure, the outside diameter d of the second end 1212 of the main body 121 may be 0.1 mm, 0.2 mm, 0.3 mm, 0.4 mm, 0.5 mm, 0.6 mm, 0.7 mm, 0.8 mm, 0.9 mm, or 1 mm. Of course, the outside diameter d of an end surface of the second end 1212 of the main body 121 may be appropriately adjusted according to selections of actual situations and settings of specific requirements, which is not limited here.

In order to reduce the wear on the screens, the shape of the pen point is generally set to be a spherical shape with a larger diameter, a hemispherical shape or a column shape with a larger diameter, which is wider than the pen point of gel pens that are usually used, which greatly affects writing experiences. Therefore, for a pen point suitable for foldable screens or terminals, it is not only necessary to ensure that the screens are not damaged during a writing process, but also to meet the needs of consumers for a more realistic writing experience. Specifically, as shown in FIGS. 1 and 2, the main body 121 is the solid of revolution obtained by rotating a generatrix 1214, wherein, the generatrix 1214 is an oblique line, and a coning angle β of the main body 121 ranges from 30° to 90°. By the above settings, the pen point of the stylus 100 can be adjusted to allow the pen point to have an appropriate angle, thereby effectively satisfying the needs of consumers for the more realistic writing experience. In this embodiment, the main body 121 is in a shape of a truncated cone. The truncated cone refers to a structure in which the cone is truncated by a plane perpendicular to its axis of rotation. The outside diameter of the main body 121 is tapered from the first end 1211 of the main body 121 toward the second end 1212 of the main body 121.

In another embodiment of the present disclosure, as shown in FIGS. 4 and 5, a difference from the above embodiment is only that the main body 121 is the solid of revolution obtained by rotating the generatrix 1214, and the generatrix 1214 is an arc. A side surface 1213 of the main body 121 is connected to the end surface of the second end 1212 of the main body 121, end points 1215 are defined at the connection between the side surface 1213 of the main body 121 and the end surface of the second end 1212 of the main body 121, and an included angle a between tangent lines of two end points 1215 at two opposite sides ranges from 30° to 90°. By the above settings, the pen point of the stylus 100 can be adjusted to have the appropriate angle, thereby effectively satisfying the needs of consumers for the more realistic writing experience. In this embodiment, the main body 121 is in a shape of a water drop, and the outside diameter of the main body 121 increases first and then tapers from the first end 1211 of the main body 121 to the second end 1212 of the main body 121.

Specifically, as shown in FIGS. 2, 3, 5, and 6, the surface modification layer 122 includes a pen point portion 1221, a first end 1221a of the pen point portion 1221 is connected to the second end 1212 of the main body 121, and an outside diameter of the pen point portion 1221 is tapered from the first end 1221a of the pen point portion 1221 to a second end 1221b of the pen point portion 1221. That is, an outside diameter of the second end 1221b of the pen point portion 1221 is less than an outside diameter of the first end 1221a of the pen point portion 1221, and the outside diameter of the second end 1221b of the pen point portion 1221 is less than the outside diameter of the second end 1212 of the main body 121. By the above settings, the pen point of the stylus 100 can be adjusted to have an appropriate angle, thereby effectively satisfying the needs of consumers for the more realistic writing experience. In this embodiment, the outside diameter of the first end 1221a of the pen point portion 1221 is greater than the outside diameter of the second end 1212 of the main body 121.

Specifically, in this embodiment of the present disclosure, an end surface of the first end 1221a of the pen point portion 1221 is at least partially connected to the end surface of the second end 1212 of the main body 121. For example, the first end 1221a of the pen point portion 1221 is connected to the second end 1212 of the main body 121, and there may be a gap between the end surface of the first end 1221a of the pen point portion 1221 and the end surface of the second end 1212 of the main body 121; or the first end 1221a of the pen point portion 1221 is connected to the second end 1212 of the main body 121, and there is no gap between the end surface of the first end 1221a of the pen point portion 1221 and the end surface of the second end 1212 of the main body 121. When there is a gap between the end surface of the first end 1221a of the pen point portion 1221 and the end surface of the second end 1212 of the main body 121, the gap can play a buffering role, so that the pen point portion 1221 can be deformed under pressure and prevent the pen point portion 1221 from scratching the screens. When there is no gap between the end surface of the first end 1221a of the pen point portion 1221 and the end surface of the second end 1212 of the main body 121, the connection strength between the pen point portion 1221 and the main body 121 can be ensured. It should be noted that the end surfaces mentioned above refer to bottom surfaces connected to side surfaces.

Specifically, as shown in FIGS. 2, 3, 5, and 6, the surface modification layer 122 further includes a first main body part 1222, the first main body part 1222 covers the side surface 1213 of the main body 121, the first end 1221a of the pen point portion 1221 is connected to a second end 1222b of the first main body part 1222, and an outside diameter of the first main body part 1222 is tapered from a first end 1222a of the first main body part 1222 to the second end 1222b of the first main body part 1222. That is, an outside diameter of the second end 1222b of the first main body part 1222 is less than an outside diameter of the first end 1222a of the first main body part 1222, and the outside diameter of the first end 1221a of the pen point portion 1221 is equal to the outside diameter of the second end 1222b of the first main body part 1222. By the above settings, the pen point of the stylus 100 can be adjusted to have an appropriate angle, thereby effectively satisfying the needs of consumers for the more realistic writing experience. In this embodiment, the surface modification layer 122 shown in FIGS. 1 to 3 is conical.

Specifically, as shown in FIGS. 5 and 6, the surface modification layer 122 further includes a second main body part 1223, the second main body part 1223 covers the side surface 1213 of the main body 121, a second end 1223b of the second main body part 1223 is connected to the first end 1222a of the first main body part 1222, and an outside diameter of the second main body part 1223 is increased from a first end 1223a of the second main body part 1223 to the second end 1223b of the second main body part 1223. That is, an outside diameter of the second end 1223b of the second main body part 1223 is greater than an outside diameter of the first end 1223a of the second main body part 1223, and the outside diameter of the first end 1222a of the first main body part 1222 is equal to the outside diameter of the second end 1223b of the second main body part 1223. By the above settings, on one hand, the material cost can be reduced, and on another hand, the weight of the pen point can be reduced, thereby facilitating users to operate the stylus for writing. In addition, a connection trace between the surface modification layer 122 and the side surface 1213 of the main body 121 can be flattened, making the appearance of the stylus 100 more beautiful and concise. In this embodiment, the surface modification layer 122 shown in FIGS. 4 to 6 has a water-drop shape, and the surface modification layer 122 completely covers the side surface of the main body 121.

Specifically, in the stylus 100 of the embodiment of the present disclosure, the end surface of the second end 1212 of the main body 121 is a sphere, and a diameter of the sphere is less than or equal to 1 mm. By the above settings, the part of the surface modification layer 122 corresponding to the end surface of the second end 1212 of the main body 121 can be ensured to have a thinner pen point, thereby satisfying the needs of users for more realistic writing. It should be noted that the end surface of the second end 1212 of the main body 121 being the sphere refers to that the end surface of the second end 1212 of the main body 121 satisfies conforms to the sphere formula.

In the stylus 100 of the embodiment of the present disclosure, the end surface of the second end 1212 of the main body 121 is the sphere, and the diameter of the sphere may be 0.1 mm, 0.2 mm, 0.3 mm, 0.4 mm, 0.5 mm, 0.6 mm, 0.7 mm, 0.8 mm, 0.9 mm, or 1 mm. Of course, the diameter of the incomplete sphere may be appropriately adjusted according to selections of actual situations and settings of specific requirements, which is not limited here.

Specifically, a contour line of a longitudinal section of the end surface of the second end 1212 of the main body 121 satisfies a following formula:

y=nx²;

wherein, n is a non-zero real number, and a y-axis of the contour line is parallel to the axial direction of the stylus. That is, the end surface of the second end 1212 of the main body 121 is a paraboloid. In this embodiment, the outside diameter d of the second end 1212 of the main body 121 is less than or equal to 1 mm. By the above settings, the part of the surface modification layer 122 corresponding to the end surface of the second end 1212 of the main body 121 can be ensured to have a thinner pen point, thereby satisfying the needs of users for more realistic writing.

As shown in FIG. 7, in this embodiment, a polymer fiber may be wound around the main body 121 by means of electrospinning to form the surface modification layer 122. Specifically, as shown in FIG. 7, polymer melt is filled in a syringe first, under a high voltage electric field of 5 KV to 20 KV, the syringe sprays the polymer fiber. By controlling movement of the main body 121, the polymer fiber is uniformly deposited on the surface of the main body 121 to obtain the surface modification layer 122, so that the nib 120 can have the pen point of velvety fibers. In this embodiment, a material of the surface modification layer 122 is the polymer fiber, and the polymer fiber is wound around the main body 121.

Specifically, if a diameter of the polymer fiber is too wide, it is difficult to control the uniformity of the surface modification layer 122. If the diameter of the polymer fiber is too thin, during the manufacturing process, because the diameter of the polymer fiber is too thin, the polymer fiber is easily interrupted, so it is difficult for the polymer fiber to wrap around the main body 121, which will increase the processing difficulty. In order to prevent the above problems, the diameter of the polymer fiber may be set to range from 50 nm to 2000 nm. By the above settings, it is beneficial to control the uniformity of the surface modification layer 122 while reducing the processing difficulty and improving the production yield.

In the stylus 100 of the embodiment of the present disclosure, the diameter of the polymer fiber may be 50 nm, 100 nm, 150 nm, 200 nm, 250 nm, 300 nm, 350 nm, 400 nm, 450 nm, 500 nm, 550 nm, 600 nm, 650 nm, 700 nm, 750 nm, 800 nm, 850 nm, 900 nm, 950 nm, 1000 nm, 1100 nm, 1200 nm, 1300 nm, 1400 nm, 1500 nm, 1600 nm, 1700 nm, 1800 nm, 1900 nm, or 2000 nm. Of course, the diameter of the polymer fiber may be appropriately adjusted according to selections of actual situations and settings of specific requirements, which is not limited here.

Specifically, the material of the surface modification layer 122 may be one or more of polyoxymethylene, polyamide, or polycarbonate. That is, the material of the polymer fiber may be one or more of polyoxymethylene, polyamide, or polycarbonate. Of course, the material of the surface modification layer 122 may be appropriately modified according to selections of actual situations and settings of specific requirements, which is not limited here.

Referring to FIG. 8, in conjunction with FIGS. 1 to 7, an embodiment of the present disclosure further provides a manufacturing method of the above stylus 100, which includes following steps.

Step B1: providing the main body 121.

Step B2: forming the surface modification layer 122 on the main body 121, wherein, the hardness of surface modification layer 122 is less than the hardness of the main body 121.

In the manufacturing method of the stylus 100 of the embodiment of the present disclosure, by covering the surface modification layer 122 on the main body 121 of the nib 120 and setting the hardness of the surface modification layer 122 to be less than the hardness of the main body 121, scratches and damages to the screens can be prevented, thereby effectively extending the service life of the screens.

Specifically, in the step of forming the surface modification layer 122 on the main body 121, as shown in FIG. 7, the polymer fiber may be wound around the main body 121 by means of electrospinning to form the surface modification layer 122. Specifically, polymer melt is filled in the syringe first, under the high voltage electric field of 5 KV to 20 KV, the syringe sprays the polymer fiber. By controlling movement of the main body 121, the polymer fiber is uniformly deposited on the surface of the main body 121 to obtain the surface modification layer 122, so that the nib 120 can have the pen point of velvety fibers. In this embodiment, the material of the surface modification layer 122 is the polymer fiber, and the polymer fiber is wound around the main body 121.

Specifically, If the diameter of the polymer fiber is too wide, it is difficult to control the uniformity of the surface modification layer 122. If the diameter of the polymer fiber is too thin, during the manufacturing process, because the diameter of the polymer fiber is too thin, the polymer fiber is easily interrupted, so it is difficult for the polymer fiber to wrap around the main body 121, which will increase the processing difficulty. In order to prevent the above problems, the diameter of the polymer fiber may be set to range from 50 nm to 2000 nm. By the above settings, it is beneficial to control the uniformity of the surface modification layer 122 while reducing the processing difficulty and improving the production yield.

In the stylus 100 of the embodiment of the present disclosure, the diameter of the polymer fiber may be 50 nm, 100 nm, 150 nm, 200 nm, 250 nm, 300 nm, 350 nm, 400 nm, 450 nm, 500 nm, 550 nm, 600 nm, 650 nm, 700 nm, 750 nm, 800 nm, 850 nm, 900 nm, 950 nm, 1000 nm, 1100 nm, 1200 nm, 1300 nm, 1400 nm, 1500 nm, 1600 nm, 1700 nm, 1800 nm, 1900 nm, or 2000 nm. Of course, the diameter of the polymer fiber may be appropriately adjusted according to selections of actual situations and settings of specific requirements, which is not limited here.

Specifically, the material of the surface modification layer 122 may be one or more of polyoxymethylene, polyamide, or polycarbonate. That is, the material of the polymer fiber may be one or more of polyoxymethylene, polyamide, or polycarbonate. Of course, the material of the surface modification layer 122 may be appropriately modified according to selections of actual situations and settings of specific requirements, which is not limited here.

Referring to FIG. 9, in conjunction with FIGS. 1 to 7, an embodiment of the present disclosure further provides an electronic device, which includes a touch display panel 200 and the stylus 100, wherein, the stylus 100 is the stylus 100 in any of the above embodiments. Since the electronic device in the embodiment of the present disclosure includes the technical solutions of all the above-mentioned embodiments, the electronic device in the embodiment of the present disclosure also has the beneficial effects of all the above-mentioned embodiments, which will not be repeated here.

The stylus and the electronic device provided by the embodiments of the present disclosure are described in detail above. Specific examples are used herein to explain the principles and implementation of the present disclosure. The descriptions of the above embodiments are only used to help understand the method of the present disclosure and its core ideas; meanwhile, for those skilled in the art, the range of specific implementation and application may be changed according to the ideas of the present disclosure. In summary, the content of the specification should not be construed as causing limitations to the present disclosure.

What is claimed is:

1. A stylus, comprising a nib, wherein the nib comprises:
a main body; and
a surface modification layer covering the main body, wherein a hardness of the surface modification layer is less than a hardness of the main body.

2. The stylus according to claim 1, wherein a material of the surface modification layer is a polymer fiber, and the polymer fiber is wound around the main body.

3. The stylus according to claim 2, wherein a diameter of the polymer fiber ranges from 50 nm to 2000 nm.

4. The stylus according to claim 1, wherein a material of the surface modification layer comprises one or more of polyoxymethylene, polyamide, or polycarbonate.

5. The stylus according to claim 1, wherein the surface modification layer has a pencil hardness less than or equal to 2B.

6. The stylus according to claim 1, wherein a height of the surface modification layer along an axial direction of the stylus ranges from 3 mm to 10 mm.

7. The stylus according to claim 1, wherein a thickness of the surface modification layer is less than or equal to 1 mm.

8. The stylus according to claim 1, further comprising a pen body, wherein a first end of the main body is connected to the pen body, the surface modification layer covers at least a second end of the main body, the main body is a solid of revolution, and an outside diameter of the second end of the main body is less than or equal to 1 mm.

9. The stylus according to claim 8, wherein a contour line of a longitudinal section of an end surface of the second end of the main body satisfies a following formula:
y=nx²;
wherein n is a non-zero real number, and a y-axis of the contour line is parallel to an axial direction of the stylus.

10. The stylus according to claim 8, wherein an end surface of the second end of the main body is a sphere, and a diameter of the sphere is less than or equal to 1 mm.

11. An electronic device, comprising:
a touch display panel; and
the stylus according to claim 1.

12. The electronic device according to claim 11, wherein a material of the surface modification layer is a polymer fiber, and the polymer fiber is wound around the main body.

13. The electronic device according to claim 12, wherein a diameter of the polymer fiber ranges from 50 nm to 2000 nm.

14. The electronic device according to claim 11, wherein a material of the surface modification layer comprises one or more of polyoxymethylene, polyamide, or polycarbonate.

15. The electronic device according to claim 11, wherein the surface modification layer has a pencil hardness less than or equal to 2B.

16. The electronic device according to claim 11, wherein a height of the surface modification layer along an axial direction of the stylus ranges from 3 mm to 10 mm.

17. The electronic device according to claim 11, wherein a thickness of the surface modification layer is less than or equal to 1 mm.

18. The electronic device according to claim 11, wherein the stylus further comprises a pen body, a first end of the main body is connected to the pen body, the surface modification layer covers at least a second end of the main body, the main body is a solid of revolution, and an outside diameter of the second end of the main body is less than or equal to 1 mm.

19. The electronic device according to claim 18, wherein a contour line of a longitudinal section of an end surface of the second end of the main body satisfies a following formula:
y=nx²;
wherein n is a non-zero real number, and a y-axis of the contour line is parallel to an axial direction of the stylus.

20. The electronic device according to claim 18, wherein an end surface of the second end of the main body is a sphere, and a diameter of the sphere is less than or equal to 1 mm.
